(19) United States
(12) Patent Application Publication
(10) Pub. No.: US 2026/0027900 A1
(43) Pub. Date: Jan. 29, 2026

(54) VEHICLE AUDIOVISUAL SYSTEM

(71) Applicant: Ford Global Technologies, LLC, Dearborn, MI (US)

(72) Inventors: Biaohe Guo, Northville, MI (US); Mark Larry, Macomb, MI (US)

(73) Assignee: Ford Global Technologies, LLC, Dearborn, MI (US)

(21) Appl. No.: 18/787,142

(22) Filed: Jul. 29, 2024

(51) Int. Cl. B60K 35/26; B60K 35/22; B60K 35/50; B60K 35/81; H04R 5/04

(52) U.S. Cl. CPC B60K 35/26; B60K 35/22; B60K 35/50; B60K 35/81; H04R 5/04; B60K 2360/785; H04R 2499/13

(57) ABSTRACT

A vehicle includes a display panel and a transparent sound-generation film. The display panel is mounted to a dashboard of the vehicle. The display panel is switchable between a private mode and a public mode. The display panel in the private mode displays visual content visible to an occupant of a first seat of the vehicle and not visible to an occupant of a second seat of the vehicle. The display panel in the public mode displays visual content visible to occupants of the first seat and of the second seat. The transparent sound-generation film is positioned to emit focused sound audible to the occupant of the first seat and not audible to the occupant of the second seat. The sound-generation film is laminated on one of the display panel or a windshield of the vehicle.

### BACKGROUND

Modern vehicles often include audiovisual systems, which can include a display screen and speakers. Display screens can be of various types suitable for displaying content legible to occupants of a vehicle, such as light-emitting diode (LED), organic light-emitting diode (OLED), liquid crystal display (LCD), plasma, digital light processing technology (DLPT), etc. Speakers may be mounted in different locations in a passenger compartment so as to emit sound to the occupants of the vehicle.

### BRIEF DESCRIPTION OF THE DRAWINGS

FIG. 1 is a top view of an example vehicle with the passenger compartment exposed for illustration.

FIG. 2 is a rear perspective view of a front of a passenger compartment of the vehicle.

FIG. 3 is a block diagram of an example audiovisual system of the vehicle.

FIG. 4 is a flowchart of an example process for operating the audiovisual system.

### DETAILED DESCRIPTION

This disclosure describes a vehicle system that can provide private visual content and sound to an occupant of a vehicle, that is, output visible and audible to that occupant and not to other occupants. The system includes a display panel and a transparent sound-generation film. The display panel is mounted to a dashboard of the vehicle. The display panel is switchable between a private mode and a public mode. The display panel in the private mode displays visual content visible to an occupant of a first seat (e.g., a front passenger seat) and not visible to an occupant of a second seat (e.g., an operator seat). The display panel in the public mode displays visual content visible to occupants of the first seat and of the second seat. The sound-generation film is positioned to emit focused sound audible to the occupant of the first seat and not audible to the occupant of the second seat. The sound-generation film is laminated on one of the display panel or a windshield of the vehicle. The sound-generation film can emit sound focused in a single direction, and the lamination of the sound-generation film on the display panel or windshield can orient the sound-generation film toward the first seat. The transparency and film shape of the sound-generation film permit the sound-generation film to be placed on the display panel or windshield. In addition to orienting the focused sound, this placement also saves packaging space for other components.

A vehicle includes a display panel and a transparent sound-generation film. The display panel is mounted to a dashboard of the vehicle. The display panel is switchable between a private mode and a public mode. The display panel in the private mode displays visual content visible to an occupant of a first seat of the vehicle and not visible to an occupant of a second seat of the vehicle. The display panel in the public mode displays visual content visible to occupants of the first seat and of the second seat. The transparent sound-generation film is positioned to emit focused sound audible to the occupant of the first seat and not audible to the occupant of the second seat. The sound-generation film is laminated on one of the display panel or a windshield of the vehicle.

In an example, the sound-generation film may be laminated on the windshield.

In an example, the first seat may be a passenger seat of the vehicle, and the second seat may be an operator seat of the vehicle. In a further example, the vehicle may lack a sound-generation film positioned to emit focused sound audible to the second seat.

In an example, the vehicle may further include a speaker positioned to output nonfocused sound audible to the occupants of the first seat and the second seat. In a further example, the vehicle may further include a computer programmed to select one of the sound-generation film and the speaker for sound output, and output sound corresponding to the visual content of the display panel to the selected one of the sound-generation film and the speaker. In a yet further example, the computer may be programmed to select the sound-generation film for sound output in response to the vehicle being in motion. In a still yet further example, the computer may be programmed to select the speaker for sound output in response to the vehicle being stationary.

In another yet further example, the computer may be programmed to select the sound-generation film for sound output in response to switching the display panel to the private mode. In a still yet further example, the computer may be programmed to select the speaker for sound output in response to switching the display panel to the public mode.

In another yet further example, the computer may be programmed to select the sound-generation film for sound output in response to an input from an occupant of the vehicle.

A computer includes a processor and a memory, and the memory stores instructions executable by the processor to select one of a transparent sound-generation film and a speaker for sound output, and output sound corresponding to visual content of a display panel of the vehicle to the selected one of the sound-generation film and the speaker. The sound-generation film is positioned to emit focused sound audible to an occupant of a first seat of a vehicle and not audible to an occupant of a second seat of the vehicle. The sound-generation film is laminated on one of the display panel or a windshield of the vehicle. The speaker is positioned to output nonfocused sound audible to the occupants of the first seat and the second seat.

In an example, the instructions may further include instructions to select the sound-generation film for sound output in response to the vehicle being in motion. In a further example, the instructions may further include instructions to select the speaker for sound output in response to the vehicle being stationary.

In an example, the instructions may further include instructions to switch the display panel between a private mode and a public mode, the display panel in the private mode displaying visual content visible to an occupant of a first seat of the vehicle and not visible to an occupant of a second seat of the vehicle, the display panel in the public mode display visual content visible to occupants of the first seat and of the second seat. In a further example, the instructions may further include instructions to select the sound-generation film for sound output in response to switching the display panel to the private mode. In a yet further example, the instructions may further include instructions to select the speaker for sound output in response to switching the display panel to the public mode.

In an example, the instructions may further include instructions to select the sound-generation film for sound output in response to an input from an occupant of the vehicle.

A method includes selecting one of a transparent sound-generation film and a speaker for sound output, and outputting sound corresponding to visual content of a display panel of the vehicle to the selected one of the sound-generation film and the speaker. The sound-generation film is positioned to emit focused sound audible to an occupant of a first seat of a vehicle and not audible to an occupant of a second seat of the vehicle. The sound-generation film is laminated on one of the display panel or a windshield of the vehicle. The speaker is positioned to output nonfocused sound audible to the occupants of the first seat and the second seat.

In an example, the sound-generation film may be laminated on the windshield.

With reference to the Figures, wherein like numerals indicate like parts throughout the several views, a vehicle 100 includes a display panel 105 and a transparent sound-generation film 110. The display panel 105 is mounted to a dashboard 115 of the vehicle 100. The display panel 105 is switchable between a private mode and a public mode. The display panel 105 in the private mode displays visual content visible to an occupant of a first seat 120a of the vehicle 100 and not visible to an occupant of a second seat 120b of the vehicle 100. The display panel 105 in the public mode displays visual content visible to occupants of the first seat 120a and of the second seat 120b. The sound-generation film 110 is positioned to emit focused sound audible to the occupant of the first seat 120a and not audible to the occupant of the second seat 120b. The sound-generation film 110 is laminated on one of the display panel 105 or a windshield 125 of the vehicle 100.

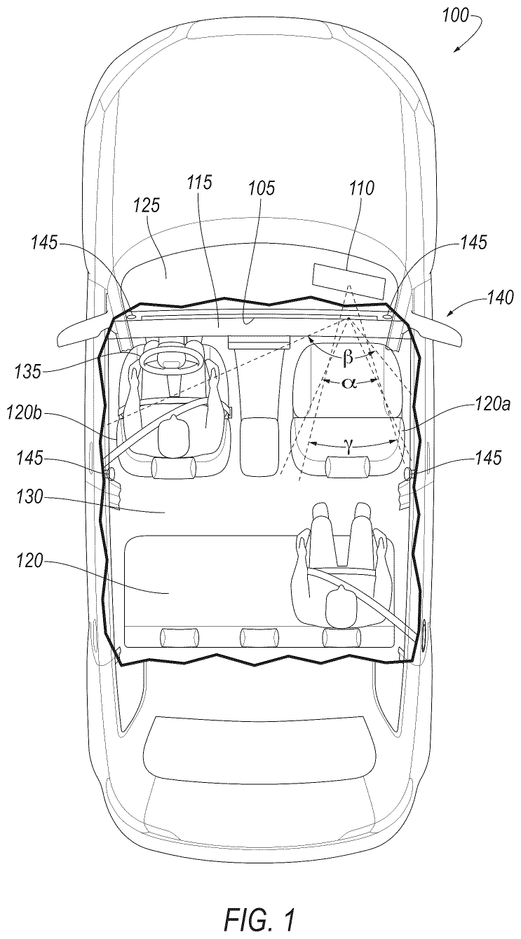

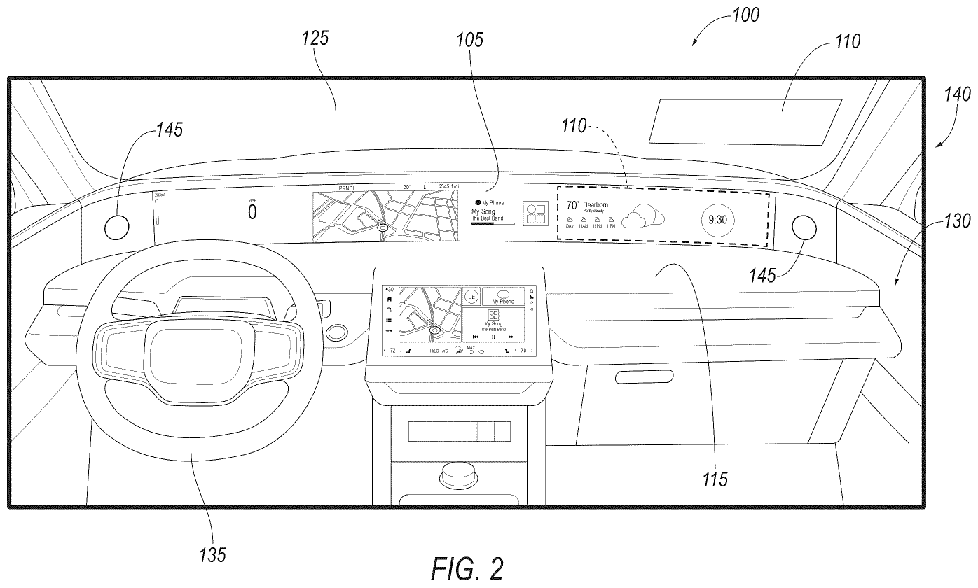

With reference to FIGS. 1 and 2, the vehicle 100 may be any passenger or commercial automobile such as a car, a truck, a sport utility vehicle, a crossover, a van, a minivan, a taxi, a bus, etc.

The vehicle 100 includes a passenger compartment 130 to house occupants, if any, of the vehicle 100. The passenger compartment 130 includes one or more of the seats 120 disposed in a front row of the passenger compartment 130 and one or more of the seats 120 disposed in a second row behind the front row. The passenger compartment 130 may also include seats 120 in a third row (not shown) at a rear of the passenger compartment 130. The seats 120 are shown to be bucket seats in the front row and bench seats in the second row, but the seats 120 may be other types. The position and orientation of the seats 120 and components thereof may be adjustable by an occupant.

The seats 120 include the first seat 120a and the second seat 120b. The term “first seat” is used herein to refer to the seat 120 positioned to receive private visual content and sound from the display panel 105 and sound-generation film 110, and the term “second seat” is used herein to refer to the seats 120 not positioned receive private visual content and sound from the display panel 105 and sound-generation film 110. For example, the first seat 120a may be a passenger seat 120, and the second seat 120b may be the operator seat 120. The first seat 120a may be the front passenger seat 120, and the second seats 120b may be the operator seat 120 and the rear seats 120. If multiple display panels 105 and sound-generation films 110 are used for multiple seats 120, then a given seat 120 may be the first seat 120a for one display panel 105 and sound-generation film 110 and the second seat 120b for another display panel 105 and sound-generation film 110. The operator seat 120 may not be the first seat 120a for any of the display panels 105 and sound-generation films 110 on board the vehicle 100.

The dashboard 115 may be disposed at a forward end of the passenger compartment 130 and face toward the front seats 120. The dashboard 115 may include vehicle controls, such as a steering wheel 135; gauges, dials, and information displays; heating and ventilation equipment; a radio and other electronics; etc. The steering wheel 135 may be positioned in front of the operator seat 120 (e.g., the second seat 120b).

The vehicle 100 includes the windshield 125. The windshield 125 extends upward and rearward from a hood of the vehicle 100. The windshield 125 provides a forward-facing view for occupants of the vehicle 100. The windshield 125 may be formed of any suitably durable transparent material, including glass such as laminated, tempered glass or plastic such as Plexiglas® or polycarbonate.

The vehicle 100 includes a user interface 140. The user interface 140 presents information to and receives information from an operator and/or other occupants of the vehicle 100. The user interface 140 may include dials, digital readouts, screens, speakers 145, and so on for providing information to the operator, such as human-machine interface (HMI) elements such as are known. The user interface 140 may include buttons, knobs, keypads, microphone, and so on for receiving information from the operator. Components of the user interface 140 may be mounted to the dashboard 115 or to other locations in the passenger compartment 130.

The vehicle 100 (e.g., the user interface 140) includes the display panel 105. The display panel 105 is mounted to the dashboard 115. The display panel 105 may be positioned to be visible to an operator or occupant in the front row of seats 120 (e.g., the first seat 120a and/or the second seat 120b), while the head of the operator or occupant is facing forward in the direction of travel of the vehicle 100, meaning that the operator or occupant may be able to view the display panel 105 by moving their eyes without moving their head. For example, the display panel 105 may be positioned upward and forward from the steering wheel 135 (e.g., to serve as an instrument panel). The display panel 105 may extend laterally from a first end of the dashboard 115 to a second end of the dashboard 115. The display panel 105 may be a panoramic display, that is, may have an aspect ratio greater than a typical widescreen aspect ratio (i.e., greater than 16:9). The display panel 105 may thus be able to display content to occupants of all the front row of seats 120 (e.g., the first seat 120a and the second seat 120b). The display panel 105 can be any suitable type for displaying content legible to the respective occupants, such as light-emitting diode (LED), organic light-emitting diode (OLED), liquid crystal display (LCD), plasma, digital light processing technology (DLPT), etc.

The display panel 105 is switchable between a private mode and a public mode. The display panel 105 in the private mode displays visual content visible to an occupant of the first seat 120a and not visible to an occupant of the second seat 120b. The display panel 105 in the public mode displays visual content visible to occupants of the first seat 120a and of the second seat 120b. The display panel 105 may have an adjustable viewing angle, such as between a narrow angle α and a wide angle β, as shown in FIG. 1. In the context of displays and screens, the term “viewing angle” refers to a range of angles relative to a display or screen where the displayed image does not experience visible degradation of the image quality. The display panel 105 in the private mode may use the narrow angle α, which may encompass the first seat 120a and not the second seat 120b, and the display panel 105 in the public mode may use the wide angle β, which may encompass the first seat 120a and the second seat 120b. The display panel 105 may use any suitable mechanism for adjusting the viewing angle, such as backlight units, liquid crystal shutters, etc. The private mode and public mode may be applied to a portion of the display panel 105, such as a lateral section forward of the first seat 120a (e.g., a right-hand third or half of the display panel 105 as seen in FIGS. 1 and 2).

The vehicle 100 (e.g., the user interface 140) includes the sound-generation film 110. The sound-generation film 110 is transparent, in other words, transmitting light through without noticeable distortion (i.e., clear). The sound-generation film 110 is a film, that is, a thin skin or membrane. The sound-generation film 110 may be laminated on the windshield 125, in other words, adhered onto the windshield 125 as an additional layer. The transparency of the sound-generation film 110 permits the occupants to see the environment outside the vehicle 100 through the sound-generation film 110. Alternatively, the sound-generation film 110 may be laminated on the display panel 105 (as shown in dashed lines in FIG. 2). The transparency of the sound-generation film 110 permits the occupants to see what is displayed on the display panel 105.

The sound-generation film 110 is an arrangement of transducers that convert an electrical signal into sound. For example, the sound-generation film 110 may emit ultrasonic waves from multiple transducers in respective locations arranged in a parametric array in the sound-generation film 110, generating an interference pattern of audible sound that is aimed in a specific direction, resulting in focused sound in that specific direction. For the purposes of this disclosure, the phrase “focused sound” is defined as sound directed along a beam that is inaudible outside of the beam. For example, the beam may have an angular width y that is no more than 45° (e.g., approximately) 15°. The beam may extend normal (i.e., perpendicular) to the sound-generation film 110. The beam may be fixed (i.e., nonadjustable), meaning that the position of the sound-generation film 110 defines the beam. One such sound-generation film 110 is manufactured by Audfly.

The sound-generation film 110 is positioned to emit focused sound audible to the occupant of the first seat 120a and not audible to the occupant of the second seat 120b. For example, the sound-generation film 110 is laminated on the windshield 125 or the display panel 105 and oriented such that the beam of sound is aimed at a typical location of a head of the occupant of the first seat 120a. The beam may extend through the first seat 120a, and the second seat 120b may be positioned outside of the beam. The vehicle 100 may lack a sound-generation film 110 positioned to emit focused sound audible to the second seat 120b (e.g., the operator seat 120).

The vehicle 100 (e.g., the user interface 140) may include a plurality of the speakers 145. The speakers 145 are electroacoustic transducers that convert an electrical signal into sound. The speakers 145 can be any suitable type for producing sound audible to the occupants (e.g., dynamic). The speakers 145 are positioned to output nonfocused sound audible to the occupants of the first seat 120a and the second seat 120b (e.g., to all the seats 120). For example, the speakers 145 may be dispersed around the passenger compartment 130, as shown in FIG. 1.

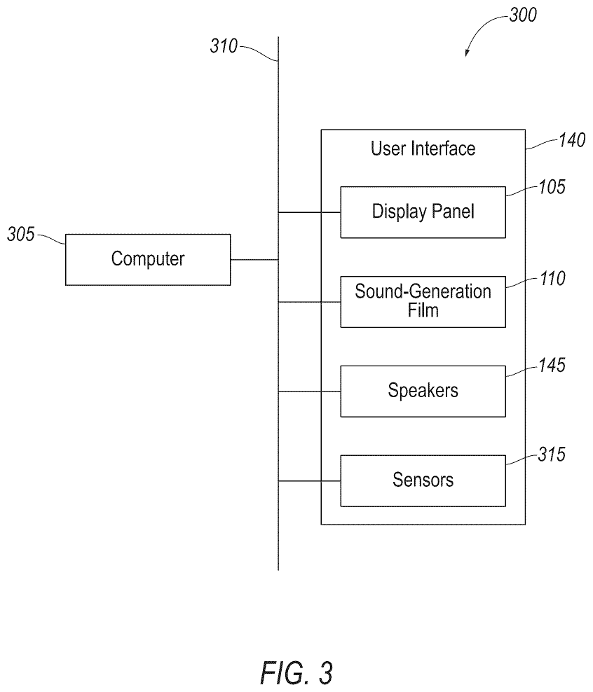

With reference to FIG. 3, the vehicle 100 includes an audiovisual system 300. The audiovisual system 300 includes a computer 305, a communications network 310, the user interface 140, the display panel 105, the sound-generation film 110, the speakers 145, and sensors 315.

The computer 305 is a microprocessor-based computing device, for example, a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The computer 305 can thus include a processor, a memory, etc. The memory of the computer 305 can include media for storing instructions executable by the processor as well as for electronically storing data and/or databases, and/or the computer 305 can include structures such as the foregoing by which programming is provided. The computer 305 can be multiple computers coupled together.

The computer 305 may transmit and receive data through the communications network 310. The communications network 310 may be a controller area network (CAN) bus, Ethernet, WiFi, Local Interconnect Network (LIN), onboard diagnostics connector (OBD-II), and/or any other wired or wireless communications network. The computer 305 may be communicatively coupled to the user interface 140, the display panel 105, the sound-generation film 110, the speakers 145, the sensors 315, and other components via the communications network 310.

The sensors 315 may generate data indicating a motion state of the vehicle 100. For example, the sensors 315 may provide data about operation of the vehicle 100, for example, wheel speed, wheel orientation, and engine and transmission data (e.g., temperature, fuel consumption, etc.). For another example, the sensors 315 may detect the location and/or orientation of the vehicle 100. The sensors 315 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. For another example, the sensors 315 may include a speedometer. The speedometer may be any sensor suitable for measuring the speed of the vehicle 100, for example, as is known, a mechanical or eddy-current speedometer, or a vehicle speed sensor. A vehicle speed sensor may use a magnetic field detector to count interruptions of a magnetic field by a toothed metal disk disposed on a driveshaft of the vehicle 100.

Returning to FIGS. 1-2, the computer 305 may be programmed to output content data via the user interface 140. Content data may include visual content and an audio stream. For the purposes of this disclosure, visual content is defined as the visual data included in content data (e.g., according to a video or image display format whereby an image and/or a frame or frames in a stream of images is provided as an array of pixels). The visual content might be a static or dynamic display of information, a video stream, etc. For example, the visual content of a navigation program may include a map that may include a node indicating a relative position of the vehicle 100, the visual content of a weather program may include various graphical weather information such as temperature, cloud cover, etc., the visual content of a video call may include a video stream of a caller, the visual content of a movie may include a video stream of the movie, and so on.

The computer 305 may output audio streams of content data from the sound-generation film 110 or the speakers 145 (selected as described below) in conjunction with outputting the visual content for the respective content data on the display panel 105. For the purposes of this disclosure, an audio stream is defined as audio data included in content data. The audio stream of content data may be synchronized to the visual content of that content data (e.g., the audio accompanying a streaming video, audio navigation instructions triggered as the present location reaches predefined points along a route displayed in the visual content, etc.). For example, conventional formats for providing streaming video with associated audio typically include mechanisms for synchronizing audio and video.

The computer 305 may be programmed to switch the display panel 105 between the private mode and the public mode, in other words, change the mode of the display panel 105 from the private mode to the public mode or from the public mode to the private mode. For example, the computer 305 may instruct the display panel 105 to change the viewing angle from the wide angle β to the narrow angle α or from the narrow angle α to the wide angle β. The computer 305 may switch the display panel 105 between the private mode and the public mode in response to an input from an occupant via the user interface 140. The input may be a selection of the mode. The computer 305 may switch the display panel 105 between the private mode and the public mode in response to content displayed on the display panel 105. For example, some types of content data may be associated with private mode or public mode and automatically display in the associated mode (e.g., entertainment programs in private mode or map applications in public mode).

The computer 305 is programmed to select one of the sound-generation film 110 and the speakers 145 for sound output. The computer 305 uses the selection for outputting sound, that is, for outputting the audio stream accompanying the visual content being displayed on the display screen. For example, the computer 305 may select the sound-generation film 110 in response to one of a plurality of trigger conditions being satisfied (i.e., met), and the computer 305 may select the speakers 145 in response to none of the trigger conditions being satisfied (i.e., by default). The trigger conditions may be, for example, an input from an occupant, the vehicle 100 being in motion, or the display panel 105 being in the private mode, as will be described in turn below, and possibly others.

The computer 305 may be programmed to select the sound-generation film 110 for sound output in response to an input from an occupant of the vehicle 100. The computer 305 may be further programmed to select the speakers 145 for sound output in response to a second input from the occupant or in response to the absence of the input from the occupant. The occupant may provide the inputs via the user interface 140. For example, the user interface 140 may display a menu structure allowing selection of settings related to sound output. The settings may include a setting for a mode of sound output to the occupant of the first seat 120a, with selectable options for private sound (i.e., the sound-generation film 110) or public sound (i.e., the speakers 145). The inputs may be the selection of the public sound or the private sound by the occupant within the settings. The selection of the public sound may be overridden by one of the other trigger conditions for selecting the sound-generation film 110 being satisfied. This overriding may persist for as long as the other trigger condition is satisfied, and the selection may then revert to the public sound if selected by the occupant in response to the other trigger condition no longer being satisfied.

The computer 305 may be programmed to select the sound-generation film 110 for sound output in response to the vehicle 100 being in motion. The computer 305 may be further programmed to select the speakers 145 for sound output in response to the vehicle 100 being stationary. For example, the computer 305 may receive a speed of the vehicle 100, in other words, a speed at which the vehicle 100 is traveling in forward or reverse, from the sensors 315 (e.g., from the speedometer). The computer 305 may compare the speed to a threshold. The threshold may be chosen to indicate that the vehicle 100 is moving (e.g., 1 mile per hour). The computer 305, in response to the speed exceeding the threshold, selects the sound-generation film 110 for sound output, and the computer 305, in response to the speed being below the threshold, selects the speakers 145 for sound output. The selection of the speakers 145 may be overridden by one of the other trigger conditions for selecting the sound-generation film 110 being satisfied. This overriding may persist for as long as the other trigger condition is satisfied, and the selection may then revert to the speakers 145 if the vehicle 100 is stationary in response to the other trigger condition no longer being satisfied.

The computer 305 may be programmed to select the sound-generation film 110 for sound output in response to switching the display panel 105 to the private mode. The computer 305 may be further programmed to select the speakers 145 for sound output in response to switching the display panel 105 to the public mode. The computer 305 may set a flag in memory when switching the display panel 105 between the private mode and the public mode. The computer 305 may select the sound-generation film 110 for sound output in response to the flag indicating private mode for the display panel 105, and the computer 305 may select the speakers 145 for sound output in response to the flag indicating public mode for the display panel 105. The selection of the speakers 145 may be overridden by one of the other trigger conditions for selecting the sound-generation film 110 being satisfied. This overriding may persist for as long as the other trigger condition is satisfied, and the selection may then revert to the speakers 145 if the display panel 105 is in public mode in response to the other trigger condition no longer being satisfied.

The computer 305 is programmed to, upon selecting the sound-generation film 110 or the speakers 145, output sound corresponding to the visual content of the display panel 105 to the selected one of the sound-generation film 110 and the speakers 145, as described above. When the selection of the sound-generation film 110 and the speakers 145 switches in the middle of an audio stream, the computer 305 outputs sound from the audio stream beginning at the point of the switch, thereby keeping the audio stream synchronized to the visual content.

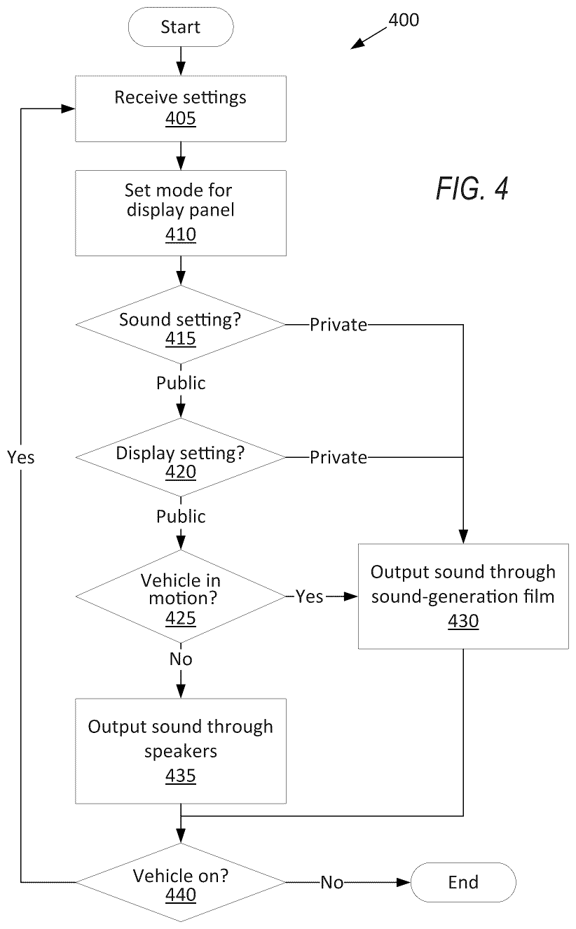

FIG. 4 is a flowchart illustrating an example process 400 for operating the audiovisual system 300. The memory of the computer 305 stores executable instructions for performing the steps of the process 400 and/or programming can be implemented in structures such as mentioned above. As a general overview of the process 400, the computer 305 receives inputs for settings and sets the mode for the display panel 105. In response to cither an input from an occupant, the display panel 105 being in the private mode, or the vehicle 100 being in motion, the computer 305 selects the sound-generation film 110 for sound output and outputs sound corresponding to the visual content of the display panel 105 to the sound-generation film 110. Otherwise, the computer 305 selects the speakers 145 and outputs sound corresponding to the visual content of the display panel 105 to the speakers 145. The process 400 continues for as long as the vehicle 100 remains on.

The process 400 begins in a block 405, in which the computer 305 receives any inputs for settings of the audiovisual system 300, such as setting the mode for the display panel 105 or selecting the sound-generation film 110 or speakers 145 for sound output, as described above.

Next, in a block 410, the computer 305 sets the display panel 105 to the private mode or the public mode, as described above.

Next, in a decision block 415, the computer 305 determines whether an input from an occupant for sound output indicates private sound or public sound, as described above. In response to private sound, the process 400 proceeds to a block 430. In response to public sound or the absence of an input, the process 400 proceeds to a decision block 420.

In the decision block 420, the computer 305 determines whether the display panel 105 is set to the private mode or the public mode in the block 410, as described above. In response to the display panel 105 being in the private mode, the process 400 proceeds to the block 430. In response to the display panel 105 being in the public mode, the process 400 proceeds to a decision block 425.

In the decision block 425, the computer 305 determines the motion state of the vehicle 100, as described above. In response to the vehicle 100 being in motion, the process 400 proceeds to the block 430. In response to the vehicle 100 being stationary, the process 400 proceeds to a block 435.

In the block 430, the computer 305 selects the sound-generation film 110 for sound output and outputs sound corresponding to the visual content of the display panel 105 to the sound-generation film 110, as described above. After the block 430, the process 400 proceeds to a decision block 440.

In the block 435, the computer 305 selects the speakers 145 for sound output and outputs sound corresponding to the visual content of the display panel 105 to the speakers 145, as described above. After the block 435, the process 400 proceeds to the decision block 440.

In the decision block 440, the computer 305 determines whether the vehicle 100 is still on, in other words, whether the vehicle 100 is in an on state, an off state, or an accessory-power state. For the purposes of this disclosure, “on state” is defined as the state of the vehicle 100 in which full electrical energy is provided to electrical components of the vehicle 100 and the vehicle 100 is ready to be driven (e.g., the engine is running); “off state” is defined as the state of the vehicle 100 in which a low amount of electrical energy is provided to selected electrical components of the vehicle 100, typically used when the vehicle 100 is being stored; and “accessory-power state” is defined as the state of the vehicle 100 in which full electrical energy is provided to more electrical components than in the off state and the vehicle 100 is not ready to be driven. Typically, an operator puts the vehicle 100 into the on state when the operator is going to operate the vehicle 100, puts the vehicle 100 into the off state when the operator is going to leave the vehicle 100, and puts the vehicle 100 into the accessory-power state when the operator is going to sit in but not operate the vehicle 100. In response to the vehicle 100 being in the on state, the process 400 returns to the block 405 to update the selection for sound output. In response to the vehicle 100 being in the off state or the accessory-power state, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.), and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. Use of “in response to,” “upon determining,” “upon selecting,” etc. indicates a causal relationship, not merely a temporal relationship. Terms such as “front,” “forward,” “longitudinal,” “back,” “rearward,” “left,” “right,” “lateral,” “upward,” “downward,” “vertical,” etc., are understood relative to the vehicle 100. The adjectives “first” and “second” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A vehicle comprising:
a display panel mounted to a dashboard of the vehicle, the display panel switchable between a private mode and a public mode, the display panel in the private mode displaying visual content visible to an occupant of a first seat of the vehicle and not visible to an occupant of a second seat of the vehicle, the display panel in the public mode displaying visual content visible to occupants of the first seat and of the second seat; and
a transparent sound-generation film positioned to emit focused sound audible to the occupant of the first seat and not audible to the occupant of the second seat, the sound-generation film laminated on one of the display panel or a windshield of the vehicle.

2. The vehicle of claim 1, wherein the sound-generation film is laminated on the windshield.

3. The vehicle of claim 1, wherein the first seat is a passenger seat of the vehicle, and the second seat is an operator seat of the vehicle.

4. The vehicle of claim 3, wherein the vehicle lacks a sound-generation film positioned to emit focused sound audible to the second seat.

5. The vehicle of claim 1, further comprising a speaker positioned to output nonfocused sound audible to the occupants of the first seat and the second seat.

6. The vehicle of claim 5, further comprising a computer programmed to select one of the sound-generation film and the speaker for sound output, and output sound corresponding to the visual content of the display panel to the selected one of the sound-generation film and the speaker.

7. The vehicle of claim 6, wherein the computer is programmed to select the sound-generation film for sound output in response to the vehicle being in motion.

8. The vehicle of claim 7, wherein the computer is programmed to select the speaker for sound output in response to the vehicle being stationary.

9. The vehicle of claim 6, wherein the computer is programmed to select the sound-generation film for sound output in response to switching the display panel to the private mode.

10. The vehicle of claim 9, wherein the computer is programmed to select the speaker for sound output in response to switching the display panel to the public mode.

11. The vehicle of claim 6, wherein the computer is programmed to select the sound-generation film for sound output in response to an input from an occupant of the vehicle.

12. A computer comprising a processor and a memory, the memory storing instructions executable by the processor to:
select one of a transparent sound-generation film and a speaker for sound output, the sound-generation film positioned to emit focused sound audible to an occupant of a first seat of a vehicle and not audible to an occupant of a second seat of the vehicle, the sound-generation film laminated on one of a display panel of the vehicle or a windshield of the vehicle, the speaker positioned to output nonfocused sound audible to the occupants of the first seat and the second seat; and
output sound corresponding to visual content of the display panel to the selected one of the sound-generation film and the speaker.

13. The computer of claim 12, wherein the instructions further include instructions to select the sound-generation film for sound output in response to the vehicle being in motion.

14. The computer of claim 13, wherein the instructions further include instructions to select the speaker for sound output in response to the vehicle being stationary.

15. The computer of claim 12, wherein the instructions further include instructions to switch the display panel between a private mode and a public mode, the display panel in the private mode displaying visual content visible to an occupant of a first seat of the vehicle and not visible to an occupant of a second seat of the vehicle, the display panel in the public mode display visual content visible to occupants of the first seat and of the second seat.

16. The computer of claim 15, wherein the instructions further include instructions to select the sound-generation film for sound output in response to switching the display panel to the private mode.

17. The computer of claim 16, wherein the instructions further include instructions to select the speaker for sound output in response to switching the display panel to the public mode.

18. The computer of claim 12, wherein the instructions further include instructions to select the sound-generation film for sound output in response to an input from an occupant of the vehicle.

19. A method comprising:
selecting one of a transparent sound-generation film and a speaker for sound output, the sound-generation film positioned to emit focused sound audible to an occupant of a first seat of a vehicle and not audible to an occupant of a second seat of the vehicle, the sound-generation film laminated on one of a display panel of the vehicle or a windshield of the vehicle, the speaker positioned to output nonfocused sound audible to the occupants of the first seat and the second seat; and
outputting sound corresponding to visual content of the display panel to the selected one of the sound-generation film and the speaker.

20. The method of claim 19, wherein the sound-generation film is laminated on the windshield.
